(19) United States
(12) Patent Application Publication
(10) Pub. No.: US 2016/0084626 A1
(43) Pub. Date: Mar. 24, 2016

(54) BRAKE PAD MEASURING GAUGE

(71) Applicant: Lisle Corporation, Clarinda, IA (US)

(72) Inventor: MARK REBLE, LUBBOCK, TX (US)

(21) Appl. No.: 14/493,258

(22) Filed: Sep. 22, 2014

(51) Int. Cl. G01B 5/00; G01B 5/06

(52) U.S. Cl. CPC G01B 5/0028; G01B 5/06; G01B 2210/00

(57) ABSTRACT

The inventive device object of the present application is an ergonomically shaped plurality of brake pad gauges, allowing a user to more efficiently measure a brake pad's thickness by inserting the device through the crevices and openings in the face of most stock and aftermarket automobile wheels. The multitude of brake pad gauges are held together by a key ring, and individually separated by a 0.5 mm washer. It is emphasized that this abstract is provided to comply with the rules requiring an abstract that will allow a searcher or other reader to quickly ascertain the subject matter of the technical disclosure.

### CLAIM OF PRIORITY FROM RELATED APPLICATIONS

The present application claims priority from U.S. Provisional Patent Application No. 61/765,020 filed on Feb. 14, 2013 to Mark Reble from Lubbock (Tex.), directed to a BRAKE PAD MEASURING GAUGE, that is hereby incorporated by reference.

### BACKGROUND OF THE INVENTION

1. Field of the Invention

The inventive device disclosed in the present application generally relates to automobile maintenance equipment and more specifically to a tool for measuring the brake pad thickness, which can be inserted through the holes or openings in the face of most stock and aftermarket automobile wheels.

2. Brief Description of the Prior Art

Automobile maintenance measuring devices are well known in the art. Various Patents and Published Patent applications are in fact directed to brake pad measuring devices. While developing the invention of the instant application independently the Inventor researched extensively the public record, as well as the current market, for brake pad measuring gauges. The most relevant examples found in the search are mentioned in the Information Disclosure Statement (IDS) attached.

Despite all the efforts listed above prior art patents describe structures that are either not truly convenient or else involve complicated, expensive, and overly difficult assembly and/or disassembly parts and procedures. Other devices have been advertised on various media but never patented or described into a printed publication.

### SUMMARY OF THE INVENTION

The inventive device object of the present application is an ergonomically shaped plurality of brake gauges, allowing a user to more efficiently measure a brake pad's thickness by inserting the device through the crevices and openings in the face of most stock and aftermarket automobile wheels. The multitude of brake pad gauges are held together by a key ring, and individually separated by a 0.5 mm washer.

It is then the principal object of the present invention to provide a device to measure a brake pad's thickness.

It is a secondary objective of the present invention to provide a portable device capable of fitting through the face of most stock and aftermarket automobile wheels.

It is an additional objective of the present invention to provide a device that does not rust or deteriorate over time and may be safely maneuvered through a vehicle's wheels. It is a final objective of the present invention to provide for a device that is relatively inexpensive to build, but that can eventually be sold at a premium.

These and other objective achieved by the device of the present invention will be apparent by the drawings, by their detailed description, and by the specification here from appended.

### BRIEF DESCRIPTION OF THE DRAWINGS

FIG. 1 is a front elevation view of one of the preferred embodiments of the “Brake Pad Measuring Gauge” in accordance with the teachings of the present invention.

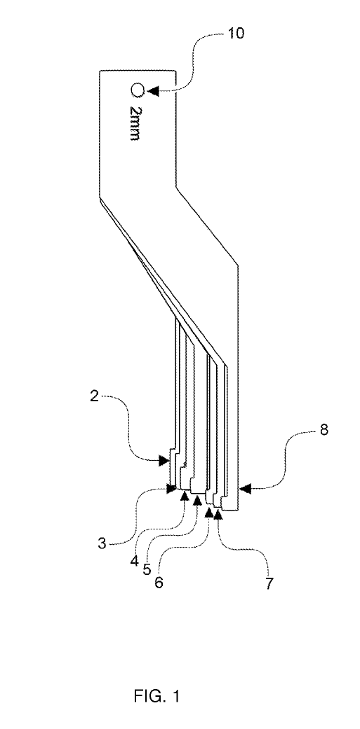

FIG. 2 is a left side elevation view of “Brake Pad Measuring Gauge” of FIG. 1.

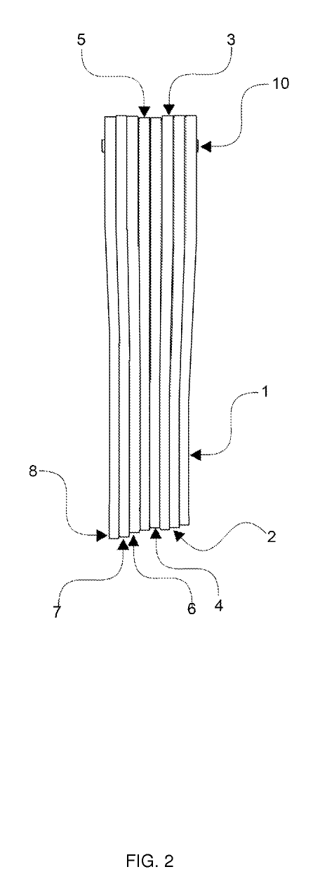

FIG. 3 is a right side elevation view of “Brake Pad Measuring Gauge” of FIG. 1.

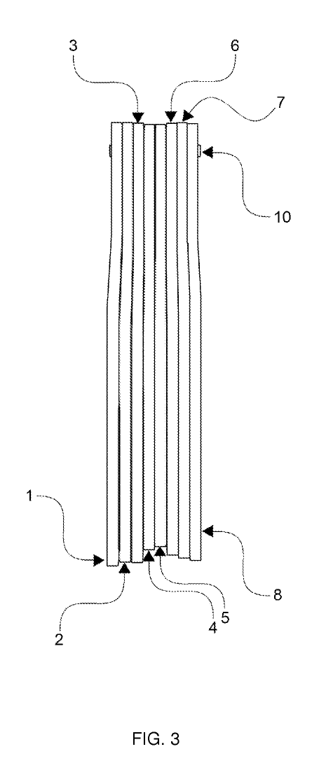

FIG. 4 is a back side elevation view of “Brake Pad Measuring Gauge” of FIG. 1.

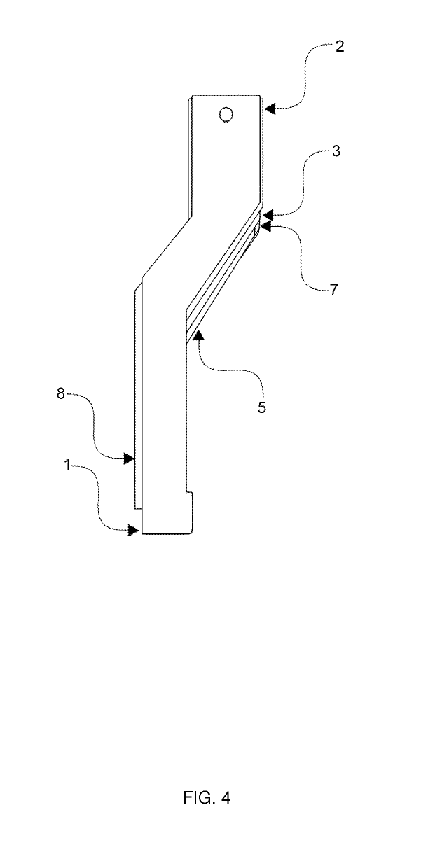

FIG. 5 is a top view of “Brake Pad Measuring Gauge” of FIG. 1.

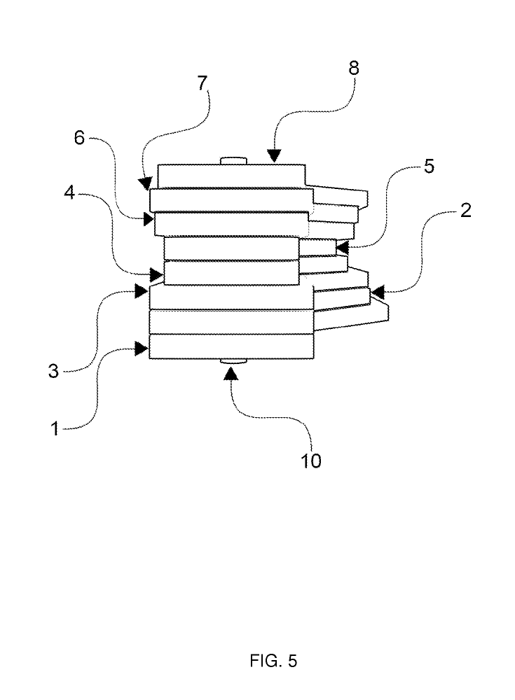

FIG. 6 is a bottom view of the “Brake Pad Measuring Gauge” of FIG. 1.

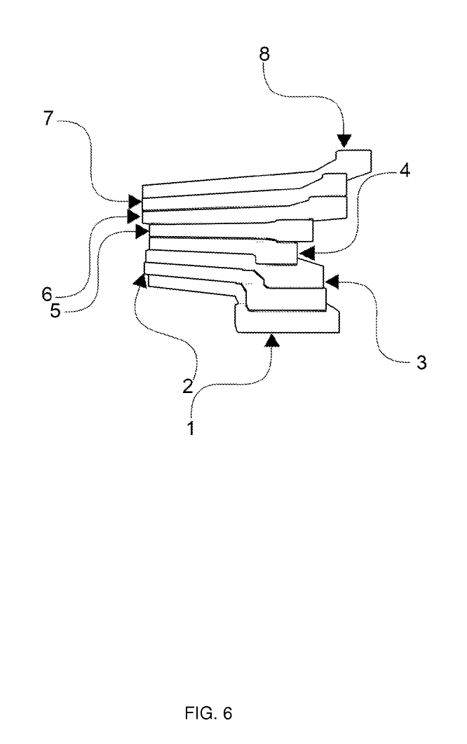

FIG. 7 is a top front perspective view of the “Brake Pad Measuring Gauge” of FIG. 1.

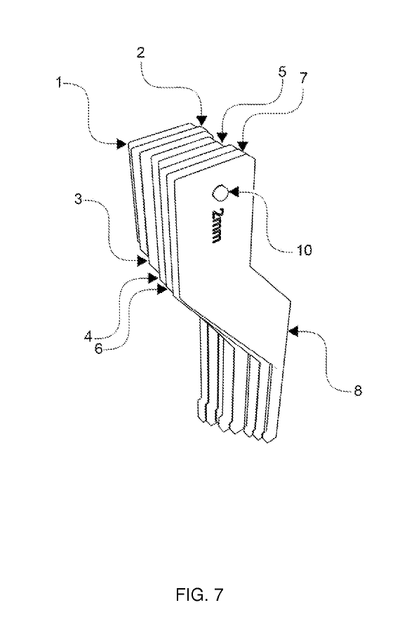

FIG. 8 is a bottom rear perspective view of the “Brake Pad Measuring Gauge” of FIG. 1.

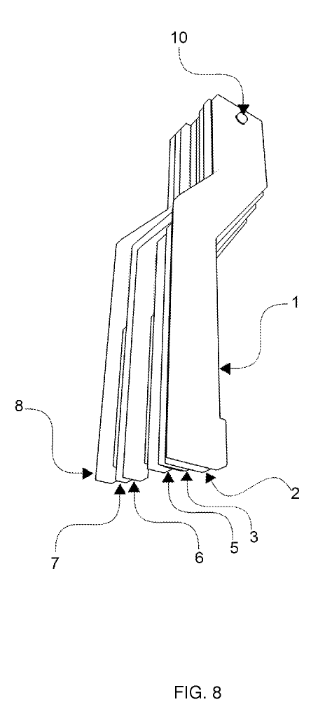

FIG. 9 is an exploded view of the “Brake Pad Measuring Gauge” of FIG. 1.

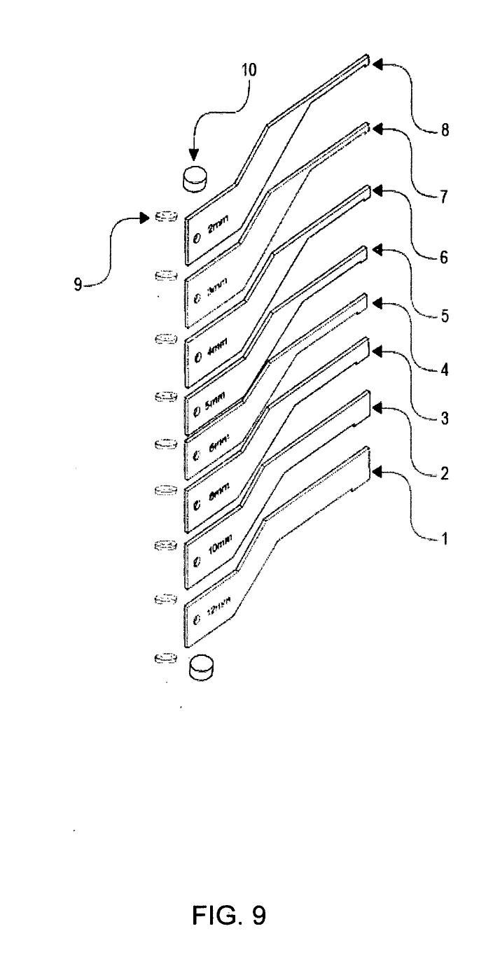

### DESCRIPTION OF THE PREFERRED EMBODIMENT

The inventive device object of the present application is an ergonomically shaped plurality of brake gauges, allowing a user to more efficiently measure a brake pad's thickness by inserting the device through the crevices and openings in the face of most stock and aftermarket automobile wheels. The multitude of brake pad gauges are held together by a key ring, and individually separated by a 0.5 mm washer. As it can be inferred from the drawings essential components of the “Brake Pad Measuring Gauge” of the present application include: A 12 mm wide brake pad gauge, a 10 mm wide brake pad gauge, a 8 mm wide brake pad gauge, a 6 mm wide brake pad gauge, a 5 mm wide brake pad gauge, a 4 mm wide brake pad gauge, a 3 mm wide brake pad gauge, a 2 mm wide brake pad gauge, a set of 0.5 mm thick washers, and a pin holder.

In one preferred embodiment of the “Brake Pad Measuring Gauge” of the present application the device features a key ring.

In a further separate preferred embodiment of the “Brake Pad Measuring Gauge” the device is color coded to alert users of at-risk or thinning brake pads.

In one of its preferred embodiments the inventive device of the present application embodies a plurality of gauges for measuring the thickness of a vehicle's brake pad comprising: A 1.5 mm thick by 12 mm wide brake pad gauge (1), a 1.5 mm thick by 10 mm wide brake pad gauge (2), a 1.5 mm thick by 8 mm wide brake pad gauge (3), a 1.5 mm thick by 6 mm wide brake pad gauge (4), a 1.5 mm thick by 5 mm wide brake pad gauge (5), a 1.5 mm thick by 4 mm wide brake pad gauge (6), a 1.5 mm thick by 3 mm wide brake pad gauge (7), and a 1.5 mm thick by 2 mm wide brake pad gauge (8) separated individually by a set of 0.5 mm thick washers (9), and held together by a gauge pin (10). In a separate preferred embodiment of the plurality of gauges for measuring the thickness of a brake pad of the present application, the 1.5 mm thick by 12 mm wide brake pad gauge (1), 1.5 mm thick by 10 mm wide brake pad gauge (2), and 1.5 mm thick by 8 mm wide brake pad gauge (3) are color-coded green, the 1.5 mm thick by 6 mm wide brake pad gauge (4), 1.5 mm thick by 5 mm wide brake pad gauge (5), and 1.5 mm thick by 4 mm wide brake pad gauge (6) are color-coded yellow, and the 1.5 mm thick by 3 mm wide brake pad gauge (7), and 1.5 mm thick by 2 mm wide brake pad gauge (8) are color-coded red.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multitude of brake pad gauges for measuring the thickness of a vehicle's wheel's brake pads comprising: A set of brake pad gauges; said brake pad gauges varying in width.

2. The multitude of brake pad gauges of claim 1 where said brake pad gauges further comprise a 1.5 mm thick by 12 mm wide brake pad gauge.

3. The multitude of brake pad gauges of claim 1 where said brake pad gauges further comprise a 1.5 mm thick by 10 mm wide brake pad gauge.

4. The multitude of brake pad gauges of claim 1 where said brake pad gauges further comprise a 1.5 mm thick by 8 mm wide brake pad gauge.

5. The multitude of brake pad gauges of claim 1 where said brake pad gauges further comprise a 1.5 mm thick by 6 mm wide brake pad gauge.

6. The multitude of brake pad gauges of claim 1 where said brake pad gauges further comprise a 1.5 mm thick by 5 mm wide brake pad gauge.

7. The multitude of brake pad gauges of claim 1 where said brake pad gauges further comprise a 1.5 mm thick by 4 mm wide brake pad gauge.

8. The multitude of brake pad gauges of claim 1 where said brake pad gauges further comprise a 1.5 mm thick by 3 mm wide brake pad gauge.

9. The multitude of brake pad gauges of claim 1 where said brake pad gauges further comprise a 1.5 mm thick by 2 mm wide brake pad gauge.

10. The multitude of brake pad gauges of claim 1 where said brake pad gauges further comprise a set of 0.5 mm thick washers.

11. The multitude of brake pad gauges of claim 1 where said brake pad gauges further comprise a gauge pin holder.

12. A separate embodiment of the multitude of brake pad gauges for measuring the thickness of a vehicle's wheel's brake pads comprising: A color-coded plurality of brake pad gauges; where said color-coded brake pad gauges indicate at-risk brake bads.

13. The multitude of brake pad gauges of claim 12 where said brake pad gauges further comprise a green-colored 1.5 mm thick by 12 mm wide brake pad gauge.

14. The multitude of brake pad gauges of claim 12 where said brake pad gauges further comprise a green-colored 1.5 mm thick by 10 mm wide brake pad gauge.

15. The multitude of brake pad gauges of claim 12 where said brake pad gauges further comprise a green-colored 1.5 mm thick by 8 mm wide brake pad gauge.

16. The multitude of brake pad gauges of claim 12 where said brake pad gauges further comprise a yellow-colored 1.5 mm thick by 6 mm wide brake pad gauge.

17. The multitude of brake pad gauges of claim 12 where said brake pad gauges further comprise a yellow-colored 1.5 mm thick by 5 mm wide brake pad gauge.

18. The multitude of brake pad gauges of claim 12 where said brake pad gauges further comprise a yellow-colored 1.5 mm thick by 4 mm wide brake pad gauge.

19. The multitude of brake pad gauges of claim 12 where said brake pad gauges further comprise a red-colored 1.5 mm thick by 3 mm wide brake pad gauge.

20. The multitude of brake pad gauges of claim 12 where said brake pad gauges further comprise red-colored a 1.5 mm thick by 2 mm wide brake pad gauge.
